(19) United States
(12) Patent Application Publication
(10) Pub. No.: US 2023/0271790 A1
(43) Pub. Date: Aug. 31, 2023

(54) TEMPORARY STORE

(71) Applicant: ROTZINGER AG, Kaiseraugst (CH)

(72) Inventor: Kurt PHILIPP, Grenzach-Wyhlen (DE)

(21) Appl. No.: 18/020,491

(22) PCT Filed: Aug. 26, 2021
(86) PCT No.: PCT/EP2021/073661

§ 371 Date: Feb. 9, 2023

(30) Foreign Application Priority Data
Aug. 28, 2020 (CH) 01066/20

(51) Int. Cl. B65G 47/26; B65G 47/51; B65G 47/61

(52) U.S. Cl. CPC B65G 47/268; B65G 47/5113; B65G 47/61; B65G 15/12

(57) ABSTRACT

The temporary store for buffering and feeding piece-goods-like foods from production to packaging by means of peripherally-circulating product carrier baskets (1) consists of an inlet area (3) and an outlet area (4) for loading and unloading the product carrier baskets, as well as accumulation sections (2) connected therebetween for filled and emptied product carrier baskets. The accumulation sections are arranged one above the other and overhead.

The invention relates to a temporary store according to the preamble of claim 1.

Temporary stores are used to decouple processes and increase efficiency in production lines—for example, in the food industry. In so doing, the articles produced in rows are transferred from a furnace or a casting system with a wide main belt and are supplied over a short path to the packaging system. These are typically biscuits, chocolate bars, or candy bars.

Depending upon the production capacity, several packaging lines are needed to pack the produced quantity with the lowest possible scrap rate. In this case, a packaging line consists of several series-connected packaging machines such as, for example, a tube packaging machine in first place, a multipack machine in second place, a cartoner in third place, and finally a palletizer.

If a machine in this line stops due to a malfunction, then the whole line fails. To prevent overflow from occurring during constant production, either an additional, so-called standby packaging line must jump in, or a temporary store buffers the excess product so that overflow of product (waste) can be avoided. These temporary stores work according to the first-in, first-out principle which, in the food industry, is usually used when handling unpackaged articles.

When designing the overall line, the installed packaging capacity must be greater than the production capacity. In general, this surplus is at least 20%. If the fill-level of the temporary store rises as a result of stops in packaging, the packaging machines can then be loaded with product at a higher speed from the store as soon as they are available again. As a rule, the fill-level of the temporary store is linked to the packaging speed. An impending overfilling of the store can therefore be counteracted early on.

Such temporary stores are known from the prior art which, in their inlet, receive the rows of product coming from production in so-called product carrier baskets, and then transport them over an accumulation area to their outlet. In the accumulation area, stoppages of the packing lines can then be buffered for a certain time, without the rows of product being lost. The buffer time is also referred to as the storage capacity. This is usually between 3 and 20 minutes.

These temporary store systems always have an accumulation area for the product carrier baskets filled with product, as well as an accumulation area for the empty product carrier baskets. The accumulation area for the filled product carrier baskets can be located above or below the inlet and outlet level. The same applies to the accumulation area for the empty product carrier baskets. In this case as well, the accumulation area can be located below or above the inlet and outlet level.

The product carrier baskets circulate through the temporary store and are filled in the inlet with rows of product and emptied in the outlet of the temporary store. An accumulation area is always below the inlet and outlet levels, and the other accumulation area always lies above the inlet and outlet levels, wherein the definition of the accumulation areas is always different, i.e., either filled or empty.

At the front, the temporary store takes the rows of product arriving in rows in the inlet from a main belt by means of product carrier baskets. The product carrier baskets consist of vertically-spaced product carrier trays which can hold the rows of product. The number of product carrier trays per basket is arbitrary, but is usually between 12 and 20 trays. This depends upon the height of the products. Furthermore, the span of the product carrier trays is also an important factor here, since the stability of the tray depends upon its thickness (height).

The rows of product are fed at a minimum speed via the main belt. By the available kinetic energy, the rows of product coming from production can then reliably slide onto the product carrier trays. Separate insertion is not required.

The product carrier baskets are suspended from a pair of chains, and are accelerated and delayed by the inlet drive of the temporary store such that an empty product carrier tray can always be provided to the inlet level on time. The filled product carrier trays are moved vertically upwards and transferred into the accumulation area of the temporary store filled with product. In so doing, empty product carrier baskets are also always moved out of the lower empty area of the temporary store in the direction of the inlet level.

The servo-controlled chain drive in the outlet of the store positions the chain cyclically downwards, so that a product carrier tray filled with product is always available on the particular discharge level. When there is an arrangement of two discharge levels, the product carrier baskets are always moved cyclically downwards vertically by two product carrier trays, in order to always have new product rows for the discharge levels in a timely manner. If only one discharge level is active, then the product carrier baskets are cyclically moved downwards by one product carrier tray.

From the outlet of the temporary store, several packaging lines can be filled with rows of product via narrow conveyor belts in the lateral direction over several discharge levels. For this purpose, a servo-controlled ejector is arranged in the outlet area of the temporary store for each packaging line at the height of the particular discharge level. The ejector pushes the row of product through the basket so that the row comes to lie centrally on the particular discharge belt. The product rows are then conveyed at synchronized speeds on both discharge levels in a lateral direction to the packaging lines.

When the discharge belts are free, they are stopped. The ejectors can then push the next product rows from the store. Discharging creates a gap to the leading product row. The trailing product row can be closed at a higher speed by means of the belts downstream from the discharge belt.

At the transfer point, the packaging lines always need a continuous, gapless product stream. When the lower discharge level is stopped, the chain drive in the outlet of the store must position the chain with the product carrier baskets in the reverse direction upwards to the upper, still-active, discharge level, so that the row of product which was actually provided for the lower discharge level can then be supplied via the upper discharge level of the connected packaging line.

This type of temporary store, with the two accumulation areas arranged vertically above one another, has a reduced overall height and is mostly used for low room heights. A typical overall height of such a temporary store is between 3 m to 4 m. This is in the height range of lower production rooms in the food sector. Usually, older, multi-story factories have this feature.

With increasing buffer capacity, these temporary stores are becoming increasingly longer at a given height. Given the design of this temporary store, several outlets can be arranged sequentially, wherein each outlet can then be supplied from an accumulation area of filled product carrier baskets with rows of product. These sequentially-arranged outlets of the temporary store then gaplessly and continuously supply all of the downstream packaging lines with product. As a result, maximum efficiency is achieved, since no products are lost when the packaging lines are stopped, and the packaging machines can always be supplied with the needed quantity of product from a product supply.

This advantage also produces a major disadvantage, since the demands on accessibility and cleaning have increased enormously nowadays. In the basic design with one outlet, these temporary store systems usually have a length of 10 m. If additional outlets are arranged one behind the other, the length can easily increase to more than 20 m. The access to the packaging lines is therefore blocked along this length, so that operating personnel and packaging material can reach the packaging lines only in a roundabout way.

Furthermore, the discharge areas within the store are inaccessible for service and cleaning. In essence, ejectors and discharge belts in the outlets within the storage are difficult to access.

The object of the invention is to propose a solution which retains the described advantages of this temporary store design without impairing the accessibility of the line.

According to the invention, this is achieved by a temporary store with the characterizing features of claim 1.

In the following, preferred exemplary embodiments of the invention are described with reference to the accompanying drawings, in which:

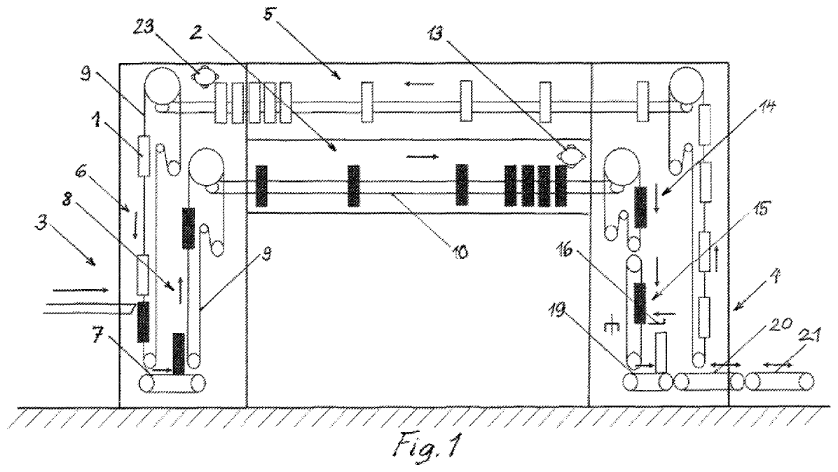

FIG. 1 shows a schematic representation of a temporary store according to the invention,

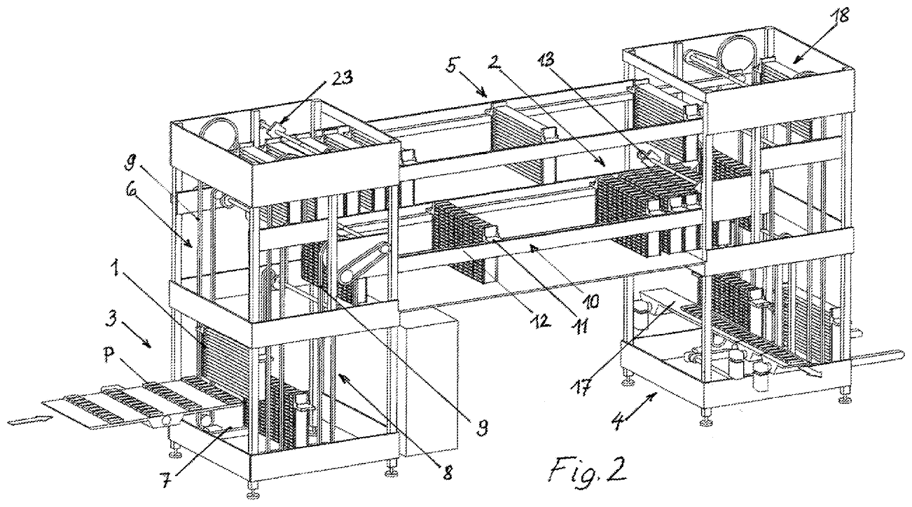

FIG. 2 shows a perspectival view of the temporary store,

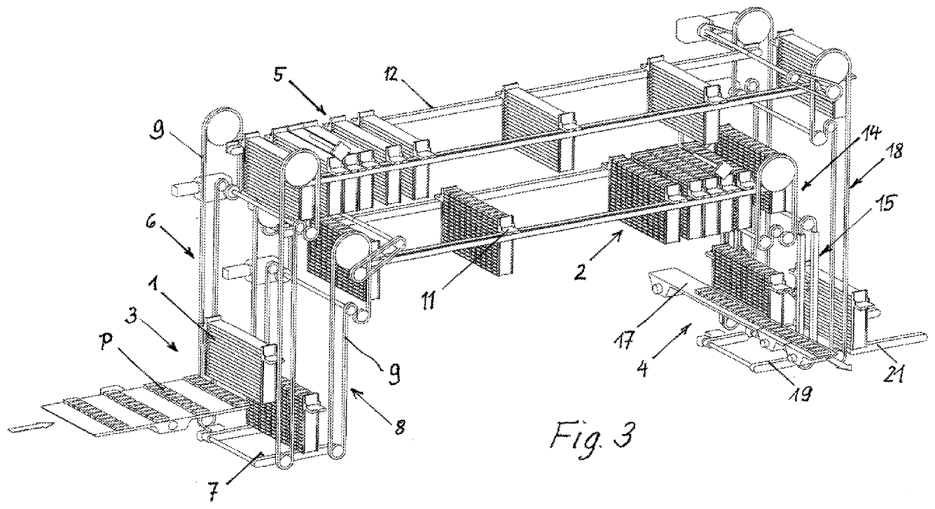

FIG. 3 shows a perspectival view of the temporary store, without frame and housing parts,

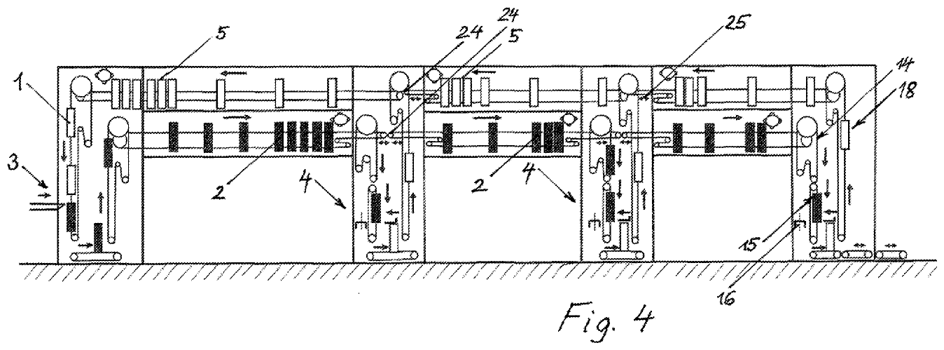

FIG. 4 shows a schematic representation of an expanded temporary store,

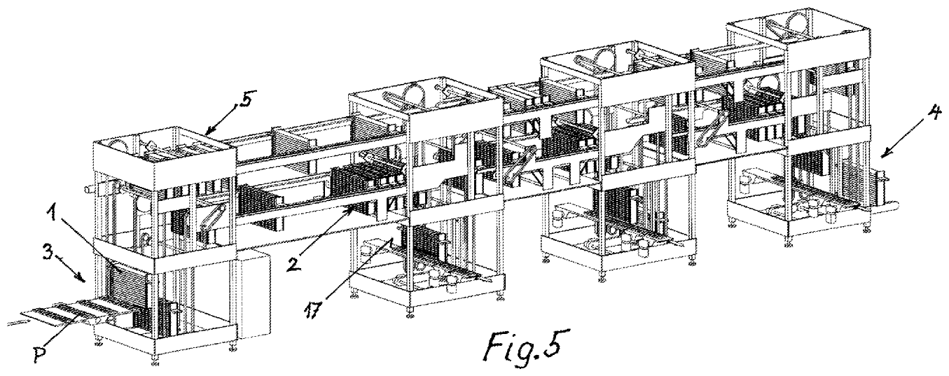

FIG. 5 shows a perspectival view of the expanded temporary store.

In essence, as shown in the figures, the circulation of the filled and empty product carrier baskets 1 according to the invention is arranged differently than is usual in known intermediate stores. For this purpose, the accumulation sections of the filled and emptied product carrier baskets are arranged above one another and overhead. The term, “overhead,” is used to express that the accumulation sections are arranged at such a height that walking and possibly driving underneath is possible.

The essential elements of the temporary store according to the invention can be seen in all the figures. In the schematic representations, the filled product carrier baskets are black, and the empty product carrier baskets are white.

In the feed, the filled baskets pass through a horizontal accumulation section 2 in the main conveying direction from the inlet area 3 to the outlet area 4 of the store. In the return, the emptied baskets pass through a horizontal accumulation section 5 opposite the main conveying direction from the outlet area to the inlet area. The two accumulation sections are arranged directly one above the other. In the present case, the returning accumulation section 5 is located above the incoming accumulation section 2. However, this can also take place in a reverse arrangement, so that the incoming accumulation section is located above the returning accumulation section.

For product to enter into the temporary store, empty product carrier baskets are moved by a lowering device 6 from the accumulation section 5 for empty baskets in a vertical direction downwards to the inlet level, so that an empty product carrier tray for receiving a product row P is always available at the inlet in a timely manner. This lowering device is designed as a chain conveyor with revolving chains 9 arranged in pairs on both sides. These chains are equipped with extended chain pins which are aligned with one another in a predetermined division on the chain. From below, the baskets are lifted from the extended chain pins in a vertical direction and are therefore suspended so as to be centered by their own weight on the chain conveyor. Via an upper deflection, the baskets are moved vertically downwards in the direction of the inlet level, in order to be loaded with rows of product.

If a product carrier basket is filled, it is moved to a lowest transfer level 7, and then moved in the main conveying direction to a waiting position, to make room for the next product carrier basket coming from above.

Once the filled product carrier basket reaches the waiting position, it is moved by a lifting device 8 in a vertical direction to the above accumulation section and transferred to this accumulation section. This lifting device is also designed as a chain conveyor. The chains, which are arranged on both sides, rotate in pairs, and are fitted with extended chain pins (not shown) which are aligned with each other at a predetermined division on the chain. From below, the baskets are lifted from the extended chain pins in a vertical direction and are therefore suspended so as to be centered by their own weight on the chain conveyor.

By means of an upper deflection, the baskets are finally deposited downwards in the vertical direction onto the accumulation section of the full baskets. The accumulation function is made possible by commercially available accumulation roller chain conveyors 10 arranged in pairs on both sides. These accumulation roller chain conveyors convey the filled baskets from the inlet area of the storage to the outlet area of the storage. These are chains that are equipped with rollers all around.

The baskets are equipped on both sides with contact surfaces 11, with which the baskets rest on the accumulation rollers of the accumulation roller chain. The two accumulation roller chains abut a guide profile 12. This guide profile is provided centrally with a longitudinal groove in which the accumulation rollers, which are also mounted centrally on the chain pins, lie hollow and can rotate freely. As a result, the accumulation rollers can roll under the baskets' contact surfaces when the baskets accumulate. The resulting dynamic pressure is not high, since this is caused only by rolling friction of the accumulation rollers.

At the end of the accumulation section in the outlet area of the storage, the front basket must always be isolated and separated. This is made possible by a separating device. For this purpose, a disk 13 equipped with cams is arranged on both sides at the end of the accumulation section above the front basket. The two disks are mechanically connected to one another via a shaft and driven by a servomotor (not shown). If a pair of cams dips into the conveying level, the transfer of the baskets is blocked. If a basket is to be separated from the accumulation, the disks equipped with cams rotate about a cam pitch and therefore release the relevant basket and block the next basket. The disks provided with cams rotate cyclically.

A basket separated from the accumulation runs into a fixed stop (not shown) arranged on both sides, and is then in a waiting position. From there, the filled baskets are taken by a removal device 14 and positioned downwards in the direction of the outlet level into a further waiting position. This removal device is designed as a chain conveyor with revolving chains arranged in pairs on both sides. The chains are equipped with extended chain pins, which are aligned with one another in a predetermined division on the chain. To be removed from the accumulation section, the basket positioned in the waiting position is raised upwards in a vertical direction with a pin pair coming from below. As a result, the basket is suspended and centered on both sides on the pin, and is then moved downwards into a further waiting position, via the upper chain deflection, in the direction of the discharge level.

From there, the removal device transfers the basket suspended on the chain pair into a downstream lowering device 15, and then moves this basket cyclically in the direction of the discharge level 16 in order to always be able to provide a row of product for discharge in a timely manner. This lowering device is also designed as a pair of chain conveyors arranged on both sides. The chains are equipped in pairs with extended chain pins which are aligned with one another at a certain division on the chain.

Discharge belts 17 that run transversely to the main conveying direction are arranged in the discharge level, and the rows of product are pushed onto them by means of pushers (not shown) known per se, in order to be conveyed to the packaging devices. Instead of the one discharge belt shown in the present exemplary embodiment, several discharge belts can be arranged one above the other, on which product rows can be transferred simultaneously from a corresponding number of product trays.

The filled baskets are therefore removed from the accumulation section and the baskets cycled downstream in the area of the discharge level by two separate devices. As a result, the baskets can be removed from the accumulation section and transported to the waiting position all together and decoupled from the cyclical operation of the lowering device. Stoppage of the product discharge due to a stoppage of a packaging line therefore has no negative influence on the handling of the baskets in the accumulation section.

As soon as the packaging line restarts, the discharging of rows of product from the leading basket can be restarted. Once the leading basket has been emptied, a subsequent basket can be transferred from the waiting position out of the removal device to the lowering device in good time, so that product replenishment is ensured for the connected packaging line.

The emptied baskets are lowered to a lowermost conveyor level 17 and then conveyed in the main conveying direction to a waiting position. In this waiting position, the baskets can either be discharged for manual removal or supplied by means of a lifting device 18 to the upper accumulation section of the empty product carrier baskets. This lowest conveyor level consists of three chain conveyor pairs 19-21 which are driven independently of one another by three servomotors.

This allows the baskets not only to be discharged in a defined manner during operation, but also to be re-introduced. For this purpose, the central chain conveyor 20 and the outlet-side chain conveyor 21 are designed to be reversible. On the chain conveyor on the discharge side, a defined number of empty baskets can be discharged and cycled for manual removal. Likewise, a certain number of empty baskets can again be provided manually on this conveyor, so that they can then be automatically re-inserted.

For re-insertion, the outlet side and center chain conveyors run in the reverse direction, bringing basket after basket into the correct position so that they can be taken by the lifting device. This lifting device is also designed as a chain conveyor arranged in pairs on both sides. These chains are equipped in pairs with extended chain pins, which are aligned with one another in a certain division on the chain. Coming from below, a pair of pins of this lifting device takes the waiting empty baskets and conveys them all the way up, and then transfers these baskets to the return of emptied baskets, which are then returned in the direction of the inlet.

At the end of the accumulation section of the empty baskets in the inlet area of the storage, there is also a separating device 23 in the design described above. The separated baskets are ready in a waiting position and, as described above, can be taken by the lowering device 6.

The individual baskets are encoded and can therefore be identified by the controller. The controller can therefore track the baskets, and knows where which basket is located in the storage cycle. This encoding can be realized, for example, with a chip which is fastened to the basket. This chip provides a transponder signal which can be processed by the controller. Another advantage of this is that certain baskets can be automatically or manually selected to be discharged—for example, for cleaning or for service purposes—at the storage outlet. In the case of malfunctions, the relevant baskets can be marked electrically and discharged, and then inspected if there are recurring malfunctions. This therefore also allows different diagnostic requirements to be covered. The fill-level of the store can be easily determined, and the development of the fill-level over time can be displayed on the control panel, etc. All drives of the storage are servo-controlled. The position of each basket in the inlet and outlet areas of the storage can be tracked incrementally via the servomotors.

A switch cabinet with the storage controller is arranged, for example, below the inlet. The switch cabinet can therefore be integrated and operated in a space-saving and very accessible manner.

In a further embodiment shown in FIG. 2, the accumulation sections of the filled and empty product carrier baskets are subdivided and extended, and additional outlet stations are integrated. These outlet stations can then again continuously feed one or more outlet levels with the connected packaging lines with product from a pre-accumulation of filled baskets. In order to integrate these additional outlet stations into the circulation of the filled and empty baskets, an additional function is added to the accumulation sections, because the emptied baskets cross the two conveying levels of the relevant accumulation sections on the way back up into the return flow of the emptied baskets. For this purpose, the accumulation sections are equipped with an additional pullnose function. As a result, the end deflections 24 of the accumulation roller chain conveyors are retracted horizontally (arrow 25) in the various accumulation zones, to provide a passage for the vertically crossing baskets. For one, the filled baskets are then lowered vertically into the lower storage zone, and the emptied baskets are moved upwards by the corresponding lifting device into the return flow of the emptied baskets. Due to the retraction, the conveying level of the affected accumulation zone is opened, and, due to the closing, the accumulation section is re-closed, and the following baskets can again pass through this area in a horizontal direction.

The main advantage of the proposed solution is that the inlet and outlet areas of the temporary store are very easily accessible for operation, servicing, and cleaning. Furthermore, access to the packaging lines is made possible below the temporary store and transverse to the main conveying direction. Furthermore, the storage can be expanded in a modular manner by any number of outlets. This solution makes it possible to feed product to the various packaging lines without realizing the usual main belts and belt-based discharge stations, and also to provide a buffer function for each connected packaging line.

1. Temporary store for buffering and feeding piece-goods-like foods from production to packaging by peripherally-circulating product carrier baskets, the temporary store comprising an inlet area and an outlet area for loading and unloading the product carrier baskets, as well as respective accumulation sections connected therebetween for filled ones of the product carrier baskets and emptied ones of the product carrier baskets, wherein said accumulation sections are arranged one on top of the other and overhead.

2. Temporary store according to claim 1, wherein the accumulation section for the emptied product carrier baskets is located above the accumulation section for the filled product carrier baskets, or vice versa.

3. Temporary store according to claim 1, wherein an inflow of the filled product carrier basket takes place in a main conveying direction, and a return of the emptied product carrier baskets takes place opposite the main conveying direction.

4. Temporary store according to claim 1, said product carrier baskets being encoded product carrier baskets, the temporary store further comprising means for controlling and tracking the encoded product carrier baskets.

5. Temporary store according to claim 1, said inlet area having lifting and lowering sections, respectively, for the filled product carrier baskets and the emptied product carrier baskets.

6. Temporary store according to claim 1, said outlet area having lifting and lowering sections, respectively, for the filled product carrier baskets and the emptied product carrier baskets.

7. Temporary store according to claim 1, further comprising additionally integrable outlet areas with lifting and lowering sections, respectively, for the filled product carrier baskets and the emptied product carrier baskets.

8. Temporary store according to claim 7, further comprising retractable end deflections of accumulation roller chain conveyors in the various accumulation sections in order to create a passage for vertically crossing said product carrier baskets.
